(19) United States
(12) Patent Application Publication
(10) Pub. No.: US 2014/0216209 A1
(43) Pub. Date: Aug. 7, 2014

(54) RETRACTABLE BOTTLE OPENER ASSEMBLIES AND METHODS THEREOF

(71) Applicant: Shrockie LLC, Oakland, CA (US)

(72) Inventor: Joel Aaron Shrock, Berkeley, CA (US)

(73) Assignee: Shrockie LLC, Oakland, CA (US)

(21) Appl. No.: 14/169,893

(22) Filed: Jan. 31, 2014

Related U.S. Application Data
(60) Provisional application No. 61/759,377, filed on Jan. 31, 2013.

(51) Int. Cl. B67B 7/16

(52) U.S. Cl. CPC B67B 7/16
USPC 81/3.25; 29/428

(57) ABSTRACT

A bottle opener assembly includes a bottle opener having a body including a first end and a second end opposed to the first end. A reel component is coupled to the first end of the bottle opener via a connecting cable. The reel component comprises an attachment structure configured to be attached to a mounting surface. A housing is coupled to the attachment structure. The housing is configured to rotate about a center axis of the attachment structure. A retraction assembly is coupled to and positioned within the housing. The retraction assembly is configured to release the connecting cable through a port in the housing when a pulling force above a threshold force is applied to the connecting cable. The retraction assembly is configured to automatically retract the connecting cable through the port when the pulling force is below the threshold force.

This application claims the benefit of U.S. Provisional Patent Application Ser. No. 61/759,377, filed Jan. 31, 2013, which is hereby incorporated by reference in its entirety.

### FIELD

This technology generally relates to bottle openers and, in particular retractable bottle opener assemblies and methods thereof.

### BACKGROUND

Bottle openers are useful tools that are found in many homes, restaurants, and bars. Bottle openers also are frequently transported, particularly along with portable ice chests, to various locations. Storage of bottle openers when not in use, either at home or at other locations, may be problematic. Bottle openers are often cast off into drawers where they may be difficult to locate. Additionally, storage may be limited in locations where portable ice chests are transported to and utilized. Both situations may lead to inconvenience of searching for a bottle opener when needed.

Current bottle openers which may be fixed in one location also present several problems. These bottle openers may require rigid attachment through the use of nails or screws. Finding an ideal location for such a bottle opener may be difficult. Depending on the location of the bottle opener, a specific positioning of the bottle may be required to operate the bottle opener. The lack of mobility of the bottle opener may be inefficient for the user. This is particularly true for bottle openers on portable ice chests, which are often stored at ground level. Such bottle openers are not easily accessible and are inconvenient for the user.

### SUMMARY

A bottle opener assembly includes a bottle opener having a body including a first end and a second end opposed to the first end. A reel component is coupled to the first end of the bottle opener via a connecting cable. The reel component comprises an attachment structure configured to be attached to a mounting surface. A housing is coupled to the attachment structure. The housing is configured to rotate about a center axis. A retraction assembly is coupled to and positioned within the housing. The retraction assembly is configured to release the connecting cable through a port in the housing when a pulling force above a threshold force is applied to the connecting cable. The retraction assembly is configured to automatically retract the connecting cable through the port when the pulling force is below the threshold force.

A method of making a bottle opener assembly includes providing a bottle opener having a body including a first end and a second end opposed to the first end. A reel component is coupled to the first end of the bottle opener via a connecting cable. The reel component comprises an attachment structure configured to be attached to a mounting surface. A housing is coupled to the attachment structure. The housing is configured to rotate about a center axis. A retraction assembly is coupled to and positioned within the housing. The retraction assembly is configured to release the connecting cable through a port in the housing when a pulling force above a threshold force is applied to the connecting cable. The retraction assembly is configured to automatically retract the connecting cable through the port when the pulling force is below the threshold force.

This exemplary technology provides a number of advantages including providing a bottle opener assembly that may be permanently attached to various surfaces, such as refrigerators or portable ice chests by way of example only, and provides easy and reliable access to the bottle opener. The bottle opener assembly is easy to install as it automatically adjusts to a standard position regardless of the position of attachment. The bottle opener assembly further provides a retractable bottle opener that allows the user to extend the bottle opener away from the attachment site for easy access and manipulation of the bottle opener. The bottle opener portion advantageously extends in the direction of force from the user which pulls the bottle opener away from the attachment site. The bottle opener automatically retracts and is advantageously configured to automatically readjust and reset to the nested, vertical starting position regardless of the direction the bottle opener was extended away for use. This technology provides enhanced safety by providing a secure connection to the structure the bottle opener assembly is connected to, which prevents the assembly from dislodging during use. Even further, in the unlikely event the bottle opener assembly does accidentally dislodge, an optional safety device can slow or stop the automatic retraction to prevent injury.

### BRIEF DESCRIPTION OF THE DRAWINGS

FIG. 1 is a front perspective view of an example bottle opener assembly;

FIG. 2 is a perspective view of the reel component of the bottle opener assembly illustrated in FIG. 1;

FIG. 3 is a partial exploded view and partial block diagram of the reel component of the exemplary bottle opener assembly as shown in FIG. 1;

FIG. 4A is a side-view of the exemplary bottle opener assembly in the default position along axis A;

FIG. 4B is a side-view of the exemplary bottle opener assembly shown in FIG. 4A with the bottle opener extended away from the reel component along axis A;

FIG. 4C is a side-view of the exemplary bottle opener assembly shown in FIG. 4A with the bottle opener extended away from the reel component at an angle from the axis A;

FIG. 4D illustrates an example of a sequence of operation of the exemplary bottle opener assembly from the position shown in FIG. 4C and returning back to the default position shown in FIG. 4A;

FIG. 5A is a perspective view of an optional safety device for use with a reel component;

FIG. 5B is a perspective phantom view of an exemplary reel component for use with the optional safety device illustrated in FIG. 5A;

FIG. 5C is a side view of an exemplary reel component attached to a mouting surface with the optional safety device illustrated in FIG. 5A in the depressed position; and

FIG. 5D is a side view of the exemplary reel component illustrated in FIG. 5C after removal from the mounting surface with the optional safety device illustrated in FIG. 5A in the extended position.

### DETAILED DESCRIPTION

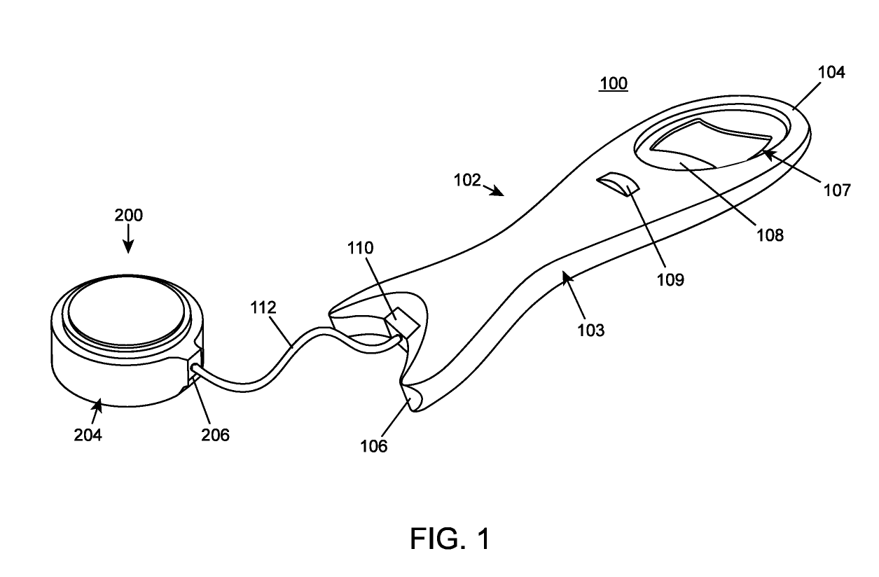

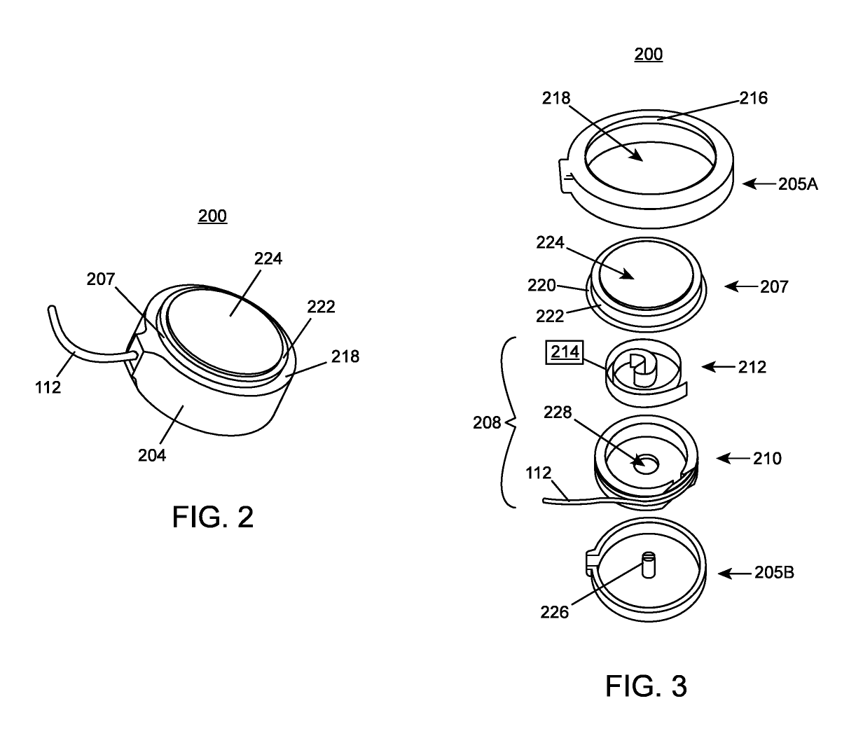

An exemplary bottle opener assembly 100 is illustrated in FIGS. 1-3. The exemplary bottle opener assembly 100 includes a retractable bottle opener 102 including body 103, bottle opener interface 108, and optional clip 110, connecting cable 112, and reel component 200 including housing 204, port 206, attachment structure 207, and retraction assembly 208 including spool 210, coil spring 212, and optional safety device 214, although the bottle opener assembly 100 could include other types and numbers of systems, devices, components, and/or other elements in other configurations. This exemplary technology provides a number of advantages including providing a bottle opener assembly that is easy to use and permanently attachable to various surfaces to provide efficient storage and access. Additionally, this technology provides a bottle opener assembly that automatically readjusts to a nested starting position when attached to a surface regardless of the angle at which the bottle opener was extended for use. Further, this technology provides a retractable bottle opener that is able to rotate and extend in the direction from which the user pulls the bottle opener to provide easy access to and use of the bottle opener while avoiding wear on the connecting cable or other string.

Referring more specifically to FIG. 1, the bottle opener 102 includes a body 103 which is constructed of plastic although the body 103 can made of other types and numbers of materials, such as metal by way of example only. The body 103 has an elongated shape configured and contoured to be easily held by a user while operating the bottle opener 102, although body 103 may have other shapes and contours. A circular aperture 107 is located proximal first end 104 and extends through body 103 and houses bottle opener interface 108, although the aperture could have other shapes and could be in other locations. Body 103 further includes optional bumper 109 which extends out of both side of body 103 to prevent body 103 from striking the mounting surface, although body 103 may include other numbers and types of elements constructed of different materials to prevent contact between body 103 and a mounting surface.

The bottle opener interface 108 is constructed of metal and is sized and configured to receive and open the bottle cap when leverage is applied via the first end 104 of bottle opener 102, although the bottle opener interface 108 may have other configurations and be constructed of other materials. In one embodiment, bottle opener interface 108 is integral to and constructed of the same material as bottle opener 102, although other configurations could be used. The second end 106 of the body 103 is configured to receive a reel component 200 when connecting cable 112 is fully retracted, although second end 106 may have other configurations. The body 103 is configured to receive an optional clip 110, which may be removably attached to body 103. Optional clip 110 permits removal of the bottle opener 102 and could be utilized to attach the reel component 200 to various other devices configured to receive the optional clip 110.

The connecting cable 112 is coupled at one end to the second end 106 of the bottle opener 102 through the optional clip 110, although the connecting cable 112 may be connected in other manners, such as being directly attached to the body 103 for example. The connecting cable 112 is constructed of string, although types of connecting cables made of other materials, such as a metal wire by way of example only, may be utilized.

The connecting cable 112 is coupled at the opposite end to the reel component 200 through a port 206. The reel component 200 includes a housing 204 with the port 206 through which the connecting cable 112 enters the housing 204, although other types of connections can be used. The housing 204 is a cylindrical shell configured to house attachment structure 207 and retraction assembly 208, although housing 204 may have other shapes and configurations to house additional elements. The port 206 is configured to allow connecting cable 112 to slide freely in and out of housing 204.

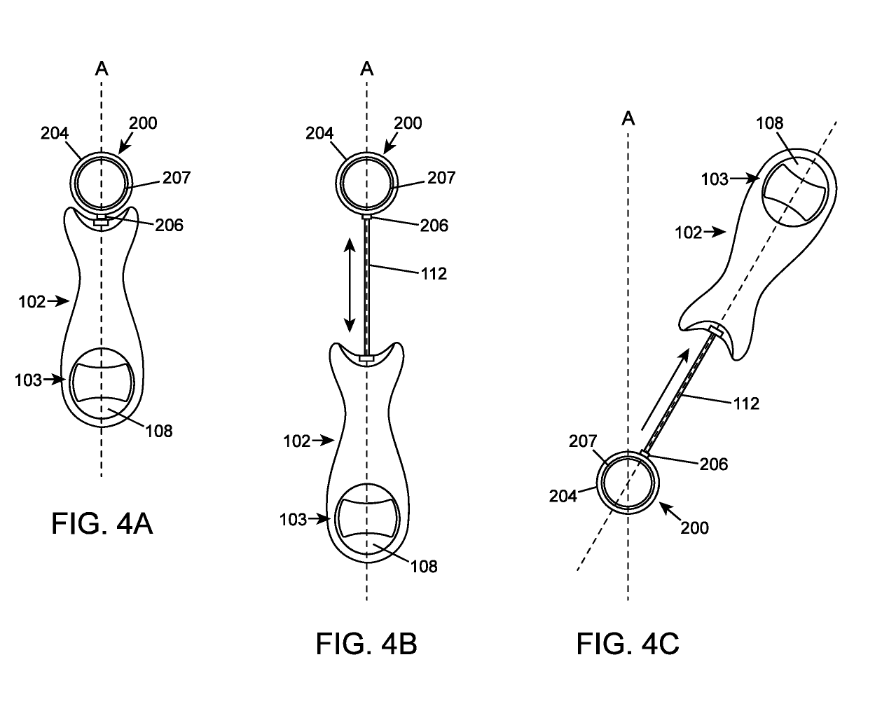

Referring more specifically to FIG. 3, the parts of an exemplary reel component 200 are illustrated in an exploded view. The housing 204 includes a back housing portion 205A and a front housing portion 205B which are coupled together to form the housing 204, although the housing 204 could be formed as a single piece. The rear housing portion 205A and the front housing portion 205B are constructed of plastic, although either of these portions may be constructed of other types and numbers of materials. Rear housing portion 205A and front housing portion 205B may be attached, by way of example only, using an adhesive, although other attachment mechanisms, such as molding the pieces together for example, may be utilized.

The rear housing portion 205A includes a track 216, which is configured to operatively couple rear housing portion 205A to the attachment structure 207, although the rear housing portion 205A may include other elements in other configurations to facilitate operative coupling to the attachment structure 207. The track 216 is located on an inner surface of the rear housing portion 205A proximal aperture 218, which is concentric with an outer surface of the rear housing portion 205A.

The attachment structure 207 is configured to rotate independently of rear housing portion 205A when the two elements are operatively attached. Attachment structure 207 includes disc portion 220, which is circular with a diameter smaller than the diameter of the rear housing portion 205A. Disc portion 220 is configured to be located in inner track 216 of rear housing portion 205A, such that disc 220 rotates freely in track 216 to allow attachment plate 207 to rotate independently of rear housing portion 205A when coupled. Although disc 220 in track 216 is described, other configurations which allow attachment structure 207 to rotate independently of rear housing portion 205A or otherwise enable the housing 204 to rotate may be utilized.

The attachment structure 207 further includes a protrusion 222, which has a diameter smaller than, and extends outwardly from, the disc portion 220. The protrusion 222 is configured to extend through the aperture 218 in the housing 204 as shown in FIG. 3, such that no part of the housing 204 comes into contact with a mounting surface allowing housing 204 to rotate freely when attachment structure 207 is mounted to a surface, such as a wall, cabinet, refrigerator, portable ice chest and the like by way of example only. Referring again to FIG. 3, the attachment structure 207 includes an adhesive 224 on a flat surface of protrusion 222, which is configured to be permanently attached to a mounting surface, such as a wall, cabinet, refrigerator, portable ice chest and the like, although attachment structure 224 may include other attachment mechanisms, such as a magnet. With this permanent attachment approach, the bottle opener assembly 100 is safer because the housing 204 is secure and can not accidentally dislodge and launch towards a user during use of the bottle opener 102.

The front housing portion 205B includes a post 226 located centrally on an inside surface of the front housing portion 205B, which is configured to receive a retraction assembly 208. The retraction assembly 208 includes a spool 210 coupled to a coil spring 212, although retraction assembly may have other elements in other configurations. The spool 210 includes a central aperture 228 which allows the spool 210 to be coupled to the front housing portion 204B through the post 226, allowing the spool 210 to rotate about the post 226. The spool 210 is configured to receive the connecting cable 112 around its outside edge as the spool 210 rotates. The coil spring 212 is connected to the post 228 and is configured to apply a retraction force to reel in the connecting cable 112 around the spool 210, although other elements may be used to supply the retraction force.

The retraction assembly 208 is configured to allow the connecting cable 112 to be gradually released via the port 206 when a pulling force is applied to the connecting cable 112 that is greater than the retraction force of the coil spring 212. In one embodiment, retraction assembly 208 further includes an optional safety device 214. The optional safety device 214 is configured to determine whether the attachment structure 207 is securely attached to a mounting surface and in the unlikely event the safety device 214 determines that attachment structure 207 is unattached or dislodged from the mounting surface, safety device 214 slows and/or stops the retraction of connecting cable 112 into reel component 200 to avoid injury.

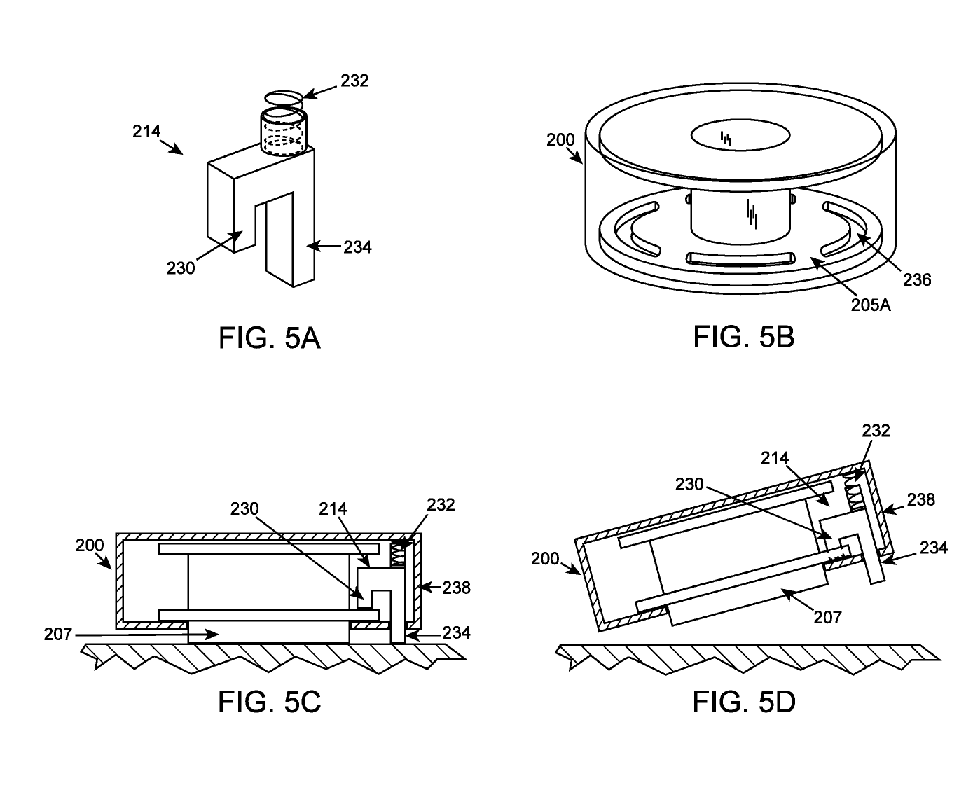

Referring now to FIG. 5A-5D, an exemplary safety device 214 is shown. Safety device 214 which includes a stopper 230, spring 232, and mounting portion 234, although safety device 214 may include other elements in other configurations. As shown in FIG. 5B, reel component 200 includes one or more slots 236 disposed on the inside surface of rear housing portion 205A which are configured to receive stopper 230. Referring now to FIGS. 5C and 5D, safety device 214 is located partially in housing 238 which is disposed on the side of reel component 200 and partially within reel component 200, although safety device 214 may be located in other locations on reel component 200. When reel component 200 is mounted to a mounting surface through attachment structure 207, as shown in FIG. 5C, mounting portion 234, which extends outside of housing 238, causes spring 232 to be depressed against the upper wall of housing 238. In this position, stopper 230 does not contact the inside surface of reel component 200. In the unlikely event that reel component 200 is dislodged from the mounting surface, as shown in FIG. 5D, spring 232 is released and mounting portion 234 extends outward from the housing 238 causing stopper 230 to be inserted into one of the slots 236 along the inside surface of reel component 200. When stopper 230 reaches the edge of one of the slots, stopper 230 causes the reel component to stop rotating to prevent the reel component 200 from retracting bottler opener 102.

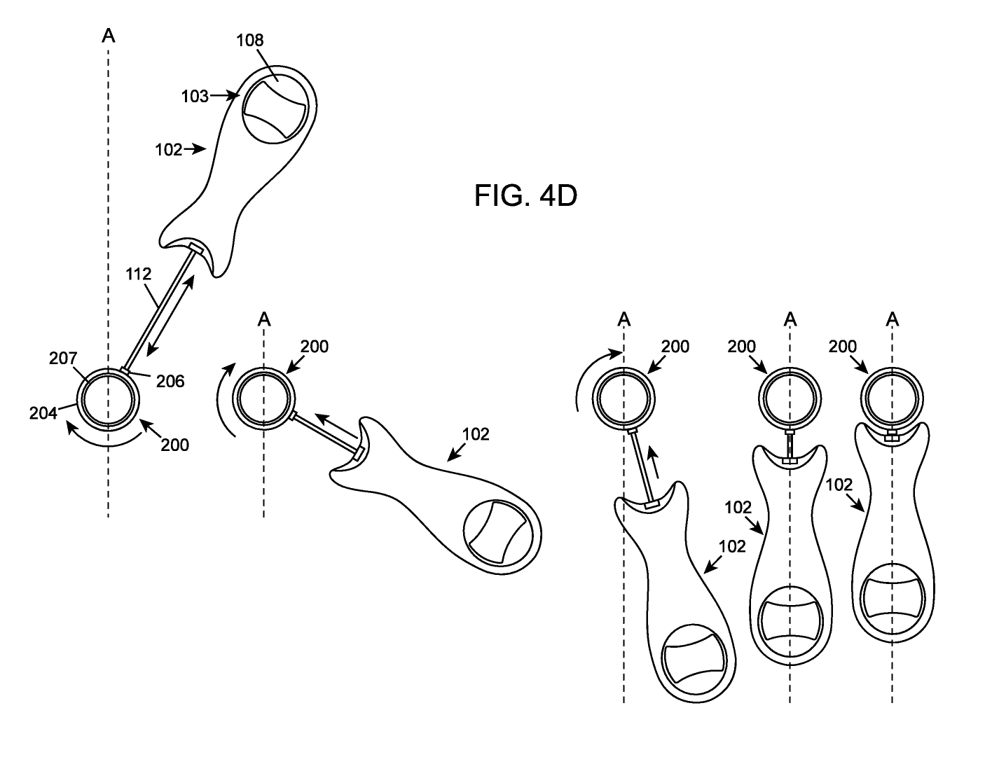

An exemplary operation of the bottle opener assembly 100 of the present invention will now be described with reference to FIGS. 1-4D. As shown in FIG. 4A, the reel component 200 of the bottle opener assembly 100 is adhesively mounted to a mounting surface, by way of example only, through the adhesive 224 on the attachment structure 207. The housing 204 rotates independently of the attachment structure 207 when attached to the mounting surface. Accordingly, the combination of gravity and the weight of the bottle opener 102 cause the housing 204 to rotate such that the bottle opener 102 hangs vertically downward in a resting or default nested position along center axis A. The weight of the bottle opener 102 is advantageously heavy enough to overcome the friction between housing 204 and attachment structure 207 causing the bottle opener 102 to self align to the tidy looking vertical nested position. Further, the weight of the bottle opener 102 is less than the threshold force for the reel component 200, such that the connecting cable 112 does not extend from just the weight of the bottle opener 102. Housing 204 advantageously rotates such that the bottle opener 102 is in the vertically downward position along center axis A regardless of the angle of attachment of reel component 200 to the mounting surface. In this default position, connecting cable 112 is fully retracted into reel component 200.

As shown in FIGS. 4B and 4C, a user may pull on the bottle opener 102 to extend bottle opener 102 from the reel component 200. When the user pulls on the bottle opener 102 with a pulling force above a threshold necessary to overcome the retraction force, the connecting cable 112 extends outwardly from the reel component 200 while the reel component 200 remains attached to the mounting surface. If the force is removed or is below the threshold, the reel component 200 automatically retracts the connecting cable 112 through port 206 back to the default nested position shown in FIG. 4A regardless of the angle at which the bottle opener 102 with the connecting cable 112 were pulled.

Referring again to FIGS. 4B and 4C, the housing 204 is able to rotate independently in any direction when the reel component 200 is attached to the mounting surface. Therefore, the housing 204, and in particular the port 206, automatically rotate about the center axis A to face the direction in which the bottle opener 102 is pulled by the user. For example, if the bottle opener 102 is pulled vertically downward from its default position, as illustrated in FIG. 4B, the housing 204 and port 206 will not need to move as the user pulls on the bottle opener 102. However, in the event that the user pulls on the bottle opener 102 in an angular direction, as shown in FIG. 4C, the tangential force applied to the interior surface of the port 206 by connecting cable 112 will cause the housing portion 204 to rotate counter-clockwise with respect to center axis A such that the port 206 is in an angular position with respect to the center axis A and faces the direction from which the bottle opener 102 is being pulled. Considering that the attachment structure 207 is independently moveable from the housing 204, negligible external stress is applied to the attachment structure 207 as the bottle opener 102 is pulled away from the reel 200 at any angle, thus helping to preserve the permanent attachment of the reel component 200 to the mounting surface for safety purposes.

FIG. 4D illustrates an exemplary operation of the bottle opener assembly 100 after the user releases the bottle opener 102 from the position illustrated in FIG. 4C. Connecting cable is gradually retracted toward the reel component 200 as the housing 204 rotates clockwise about center axis A. The bottle opener 102 returns to the default nested position with bottle opener 102 extending vertically downward along center axis A to provide a tidy appearance of the bottle opener assembly 100 in the nested, vertical position.

Accordingly, as illustrated and described with the examples herein, this technology provides a bottle opener assembly that may be permanently attached to various surfaces, such as refrigerators or portable ice chests, by way of example only, and provides easy and reliable access to the bottle opener. The bottle opener assembly is easy to install as it automatically adjusts to a standard position regardless of the position of attachment. The bottle opener assembly further provides a retractable bottle opener that allows the user to extend the bottle opener away from the attachment site for easy access and manipulation of the bottle opener. The bottle opener portion advantageously extends in the direction of force from the user which pulls the bottle opener away from the attachment site. The bottle opener automatically retracts and is advantageously configured to automatically readjust and reset to the nested starting position regardless of the direction the bottle opener was extended away for use. This technology provides enhanced safety by providing a secure connection to the structure the bottle opener assembly is connected to in order to prevent the assembly from dislodging during use. Even further, in the unlikely event the bottle opener assembly does accidentally dislodge, an optional safety device can slow or stop the automatic retraction to prevent injury.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A bottle opener assembly comprising:
a bottle opener having a body including a first end and a second end opposed to the first end; and
a reel component coupled to the first end of the bottle opener via a connecting cable, the reel component comprising:
an attachment structure configured to be attached to a mounting surface;
a housing coupled to the attachment structure, the housing configured to rotate about a center axis; and
a retraction assembly coupled to and positioned within the housing, the retraction assembly configured to release the connecting cable through a port in the housing when a pulling force above a threshold force is applied to the connecting cable, the retraction assembly configured to automatically retract the connecting cable through the port when the pulling force is below the threshold force.

2. The bottle opener assembly of claim 1 wherein the housing rotates independently of the attachment structure when the attachment structure is attached to a mounting surface.

3. The bottle opener assembly of claim 2 wherein the independently rotatable housing of the reel component causes the bottle opener to be vertically oriented with respect to ground when in a retracted position, and further wherein the independently rotatable housing of the reel component allows the bottle opener to be pulled away from the reel component at any angle when in an extended position.

4. The bottle opener assembly of claim 3 wherein the port of the housing is oriented at a first angular position with respect to the center axis of the attachment structure when the bottle opener is in use.

5. The bottle opener assembly of claim 4 wherein the housing rotates and the port is oriented at a second angular position.

6. The bottle opener assembly of claim 1 wherein the body comprises a circular aperture proximal to the second end.

7. The bottle opener assembly of claim 6 further comprising a bottle opening element coupled to the body, wherein the bottle opening element is positioned within the circular aperture.

8. The bottle opener of claim 1 wherein the retraction assembly further comprises a safety mechanism configured to slow the retraction of the connecting cable through the port when the attachment structure is released from the mounting surface.

9. The assembly of claim 1 wherein the attachment structure includes an adhesive on a side adapted to mount the reel component to a surface.

10. A method of making a bottle opener assembly comprising:
providing a bottle opener having a body including a first end and a second end opposed to the first end; and
providing a reel component coupled to the first end of the bottle opener via a connecting cable, the reel component comprising:
an attachment structure configured to be attached to a mounting surface;
a housing coupled to the attachment structure, the housing configured to rotate about a center axis; and
a retraction assembly coupled to and positioned within the housing, the retraction assembly configured to release the connecting cable through a port in the housing when a pulling force above a threshold force is applied to the connecting cable, the retraction assembly configured to automatically retract the connecting cable through the port when the pulling force is below the threshold force.

11. The method of claim 10 wherein the housing rotates independently of the attachment structure when the attachment structure is attached to a mounting surface.

12. The method of claim 11 wherein the independently rotatable housing of the reel component causes the bottle opener to be vertically oriented with respect to ground when in a retracted position, and further wherein the independently rotatable housing of the reel component allows the bottle opener to be pulled away from the reel component at any angle when in an extended position.

13. The method of claim 12 wherein the port of the housing is oriented at a first angular position with respect to the center axis of the attachment structure when the bottle opener is in use.

14. The method of claim 13 wherein the housing rotates and the port is oriented at a second angular position.

15. The method of claim 10 wherein the body comprises a circular aperture proximal to the second end.

16. The method of claim 15 further comprising;
providing a bottle opening element coupled to the body, wherein the bottle opening element is positioned within the circular aperture.

17. The method of claim 10 wherein the retraction assembly further comprises a safety mechanism configured to slow the retraction of the connecting cable through the port when the attachment structure is released from the mounting surface.

18. The method of claim 10 wherein the attachment structure includes an adhesive on a side adapted to mount the reel component to a surface.
